(19) United States
(12) Patent Application Publication
(10) Pub. No.: US 2012/0299701 A1
(43) Pub. Date: Nov. 29, 2012

(54) METHOD AND APPARATUS FOR PASSCODE ENTRY

(75) Inventors: Yanming Zou, Beijing (CN); Xiaohui Xie, Beijing (CN); Changsong Liu, Beijing (CN); Yan Chen, Beijing (CN)

(73) Assignee: NOKIA CORPORATION, Espoo (FI)

(21) Appl. No.: 13/520,064

(22) PCT Filed: Dec. 30, 2009
(86) PCT No.: PCT/CN2009/076249

§ 371 Date: Aug. 1, 2012

(51) Int. Cl. G06F 7/04

(52) U.S. Cl. 340/5.54

(57) ABSTRACT

An apparatus and method for receiving a first user input comprising a first set of strokes; causing a representation of the first set of strokes to be displayed; whilst the representation of the first set of strokes is displayed, receiving a second user input comprising a second set of strokes; causing a representation of each of the second set of strokes to be displayed as it is received, the representation of the second set of strokes at least partially overlapping the representation of the first set of strokes; resolving the first user input into a first character; and resolving the second user input into a second character.

### TECHNICAL FIELD

The present application relates generally to the concealed entry of a text string, for example a passcode.

### BACKGROUND

Developments in information technology and security have led to an expectation amongst users that they should be able to record and access information securely regardless of the environment in which they do so. Whereas it would once have been unthinkable to provide remote access to confidential information, it is now common for remote workers to connect to company networks using Virtual Private Networking (VPN), for holders of bank account information to control their finances from a mobile telephone, and for the users of mobile terminals to authenticate themselves with a wide variety of e-mail and social networking tools whilst surrounded by people they may not know.

It is therefore now common for users to enter confidential information, for example passcodes, in very public environments, where a third party's observation of such data could compromise user or data security. It is for just this reason that expensive security filters have proven popular for laptop computers, the filters restricting the viewing angle of the computer screen in an attempt to prevent unwelcome third party observation of information displayed on the computers screen.

### SUMMARY

According to a first exemplary embodiment, the present invention provides a method comprising: receiving a first user input comprising a first set of strokes; causing a representation of the first set of strokes to be displayed; whilst the representation of the first set of strokes is displayed, receiving a second user input comprising a second set of strokes; causing a representation of each of the second set of strokes to be displayed as it is received, the representation of the second set of strokes at least partially overlapping the representation of the first set of strokes; resolving the first user input into a first character; and resolving the second user input into a second character.

According to a second exemplary embodiment, the present invention provides an apparatus comprising: a processor; and memory including computer program code, the memory and the computer program code configured to, working with the processor, cause the apparatus to perform at least the following: receive a first user input comprising a first set of strokes; cause a representation of the first set of strokes to be displayed; whilst the representation of the first set of strokes is displayed, receive a second user input comprising a second set of strokes; cause a representation of each of the second set of strokes to be displayed as it is received, the representation of the second set of strokes at least partially overlapping the representation of the first set of strokes; resolve the first user input into a first character; and resolve the second user input into a second character.

According to a third exemplary embodiment, the present invention provides an apparatus comprising: means for receiving a first user input comprising a first set of strokes; means for causing a representation of the first set of strokes to be displayed; means for, whilst the representation of the first set of strokes is displayed, receiving a second user input comprising a second set of strokes; means for causing a representation of each of the second set of strokes to be displayed as it is received, the representation of the second set of strokes at least partially overlapping the representation of the first set of strokes; means for resolving the first user input into a first character; and means for resolving the second user input into a second character.

According to a fourth exemplary embodiment, the present invention provides a computer program product comprising a computer-readable medium bearing computer program code embodied therein for use with a computer, the computer program code comprising: receiving a first user input comprising a first set of strokes; causing a representation of the first set of strokes to be displayed; whilst the representation of the first set of strokes is displayed, receiving a second user input comprising a second set of strokes; causing a representation of each of the second set of strokes to be displayed as it is received, the representation of the second set of strokes at least partially overlapping the representation of the first set of strokes; resolving the first user input into a first character; and resolving the second user input into a second character.

According to a first exemplary embodiment, the present invention provides a computer-readable medium encoded with instructions that, when executed by a computer, perform: receiving a first user input comprising a first set of strokes; causing a representation of the first set of strokes to be displayed; whilst the representation of the first set of strokes is displayed, receiving a second user input comprising a second set of strokes; causing a representation of each of the second set of strokes to be displayed as it is received, the representation of the second set of strokes at least partially overlapping the representation of the first set of strokes; resolving the first user input into a first character; and resolving the second user input into a second character.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus according to an exemplary embodiment of the invention;

FIG. 2 is an exemplary illustration of user-entered strokes without overlapping;

FIG. 3 is an exemplary illustration of user-entered strokes with overlapping;

FIGS. 4a-h are a series of exemplary illustrations showing user entry of the strokes of FIG. 3;

FIG. 5 is an exemplary illustration of user-entered strokes with overlapping;

FIGS. 6a-h are a series of exemplary illustrations showing user entry of the strokes of FIG. 5;

FIG. 7 is an exemplary illustration of user-entered strokes with overlapping;

FIGS. 8a-h are a series of exemplary illustrations showing user entry of the strokes of FIG. 7;

FIG. 9 is an exemplary illustration of dummy strokes;

FIG. 10 is an exemplary illustration of dummy strokes;

FIG. 11 is an exemplary illustration of dummy strokes;

FIG. 12 is a flow chart illustrating a method according to an exemplary embodiment of the invention;

FIG. 13 is a flow chart illustrating a method according to an exemplary embodiment of the invention;

FIG. 14 is an exemplary illustration of the determination of a measure of overlap;

FIG. 15 is an exemplary illustration of the determination of a measure of overlap; and

FIG. 16 is an exemplary illustration of the determination of a measure of overlap.

### DETAILED DESCRIPTON OF THE DRAWINGS

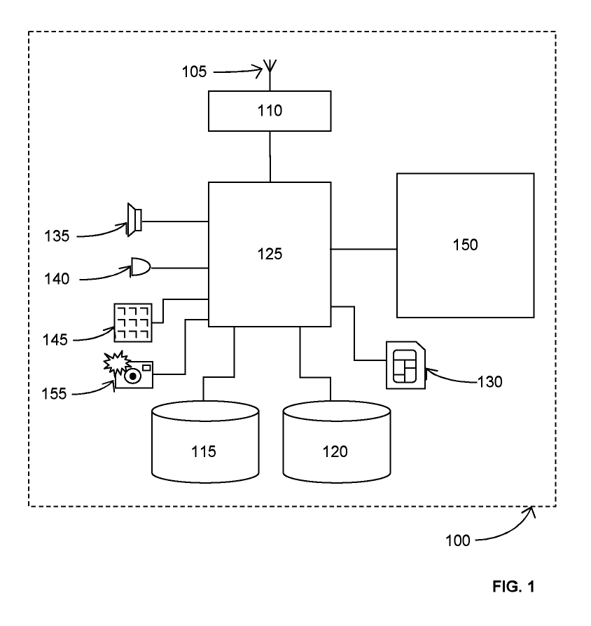

An example embodiment of the present invention and its potential advantages are understood by referring to FIGS. 1 through 16 of the drawings.

FIG. 1 illustrates a Mobile Communication Device (MCD) 100 according to an exemplary embodiment of the invention. The MCD 100 may comprise at least one antenna 105 that may be communicatively coupled to a transmitter and/or receiver component 110. The MCD 100 also comprises a volatile memory 115, such as volatile Random Access Memory (RAM) that may include a cache area for the temporary storage of data. The MCD 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The MCD may comprise a processor 125 that can use the stored information and data to implement one or more functions of the MCD 100, such as the functions described hereinafter.

The MCD 100 may comprise one or more User Identity Modules (UlMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The MCD 100 may comprise a number of user interface components. For example, a microphone 135 and an audio output device such as a speaker 140. The MCD 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the MCD 100. For example, the keypad 145 may comprise a conventional QWERTY (or local equivalent) keypad arrangement. The keypad 145 may also comprise one or more soft keys with associated functions that may change depending on the operation of the device. In addition, or alternatively, the MCD 100 may comprise an interface device such as a joystick or other user input interface.

The MCD 100 may comprise one or more display devices such as a screen 150. The screen 150 may be a touch screen, in which case it may be configured to receive input from a single point of contact, multiple points of contact, and/or the like. In such an embodiment, the touch screen may determine input based on position, motion, speed, contact area, and/or the like. Suitable touch screens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touch screen including touch events that involve actual physical contact and touch events that do not involve physical contact but that are otherwise detected by the touch screen, such as a result of the proximity of the selection object to the touch screen. The touch screen may be controlled by the processor 125 to implement an on-screen keyboard.

The MCD 100 may comprise a media capturing element such as a video and/or stills camera.

The MCD 100 may comprise logic for performing handwriting recognition, whereby received user-inputted strokes are resolved into textual characters. Such logic may comprise computer software stored in the memories 115, 120 and/or firmware or hardware comprised by the MCD 100. The MCD 100 may have access to handwriting recognition functions that are served from a remote location—for example, it may be configured to send stroke information to a remote server from which it will subsequently receive recognised text.

Stroke information may, in some embodiments, be entered via a touch screen, or other touch-sensitive input device (for example, a graphics tablet, or touchpad). In some embodiments, stroke information may be received optically, for example by recording images, using the camera 155, of a whiteboard or other medium upon which visible stroke information has been or is being marked (e.g. in ink). Stroke information may also be received by monitoring the motion of a physical or virtual object—for example the position of a cursor on the display 150, or of a finger viewable by the camera 155. Other methods of receiving stroke information are possible and may be used in addition to, or in place of, those described above. Other stroke-receiving input means may also be used, for example a digital pen, such as a pen that includes at least one accelerometer for detecting strokes drawn with the pen.

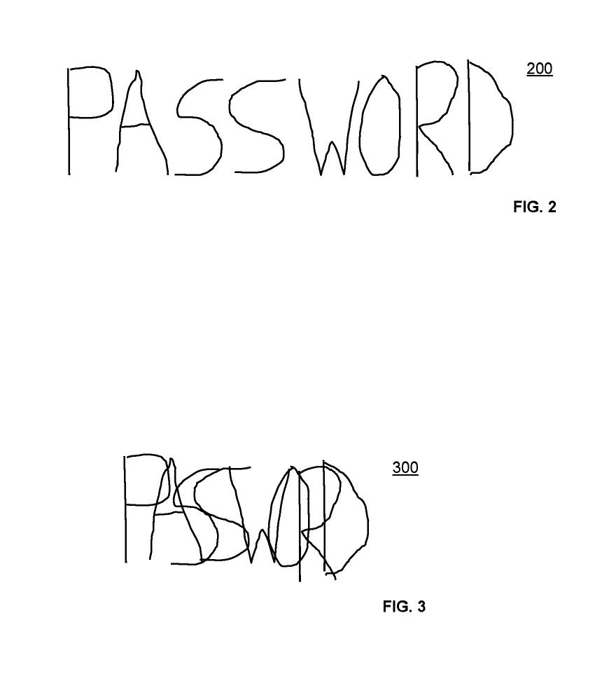

FIG. 2 is an illustration of a collection of strokes 200 received by the MCD 100 when by a user entering a passcode. In this case, the passcode is the word “PASSWORD” and the strokes 20 can clearly be observed to spell this. MCD 100 could resolve the strokes into the letters “P”, “A”, “S”, “S”, “W”, “0”, “R”, and “D” and determine that the passcode has been entered satisfactorily. It is useful to the user if representations of the strokes that he has entered remain visible to him to assist him in correctly locating subsequent strokes relative to those already entered; however, this has the effect that the entered strokes are visible to other people who may be able to view the displayed strokes. In the case of the strokes in FIG. 1, these are easily legible by third party observers who are able to view them either character-by-character, or as a whole word. The user entering the passcode therefore risks compromising it by allowing third parties to view it as he enters his strokes.

FIG. 3 is an illustration of the strokes 300 received by the MCD 100 when the same passcode “PASSWORD” has been entered using one example of overlapping characters. Compared to the strokes 200 of FIG. 2, the strokes 300 of FIG. 3 are less legible to an observer.

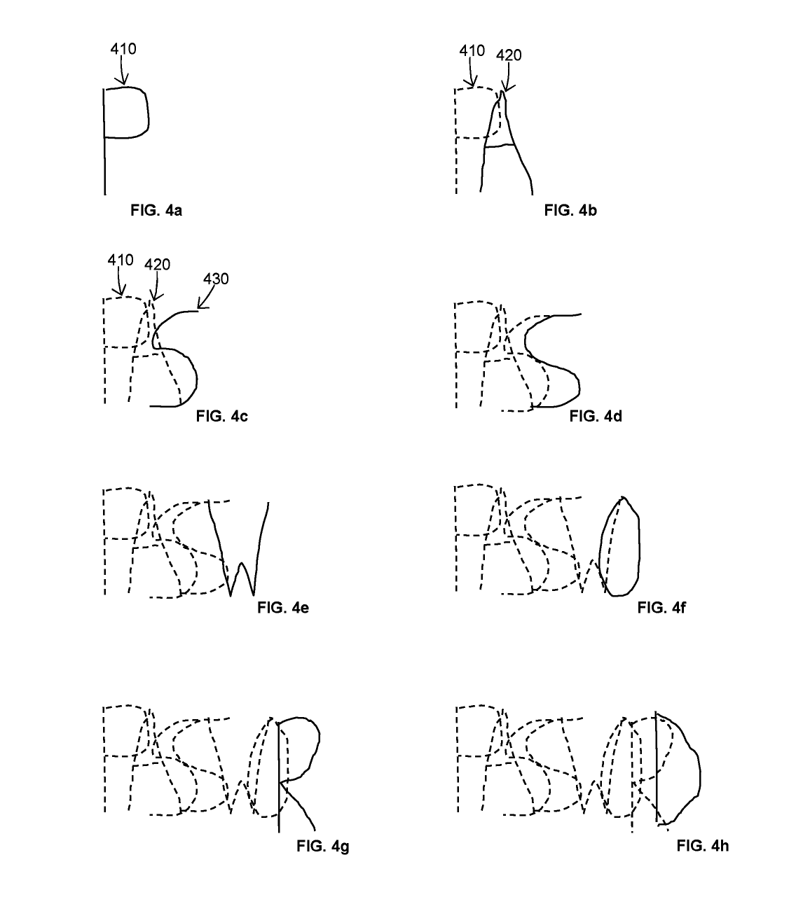

FIGS. 4a-h show the user entry of the strokes 300 that make up FIG. 3.

In FIG. 4a a user has entered the strokes 401 that correspond to the letter “P”. For the moment, the character “P” is clearly legible.

In FIG. 4b the user has entered the strokes 402 that make up the character “A”. These strokes overlap those 401 that already make up the character “P”, which have been shown in dashed lines, for clarity. The overlapped strokes 401, 402 are more difficult for an observer to read than those making up the first two characters of the strokes 200 in FIG. 2.

As more strokes, corresponding to more characters, are added, it becomes increasingly difficult to identify any of the characters that they make up, due to the increased total amount of overlap. In FIG. 4c strokes 403 corresponding to the characters “S” have been added to those 401, 402 corresponding to the characters “P” and “A” (now all shown in dashed lines, for clarity). The new strokes 403 overlap those 402 of the letter “A”, and this increase in the total amount of overlapping makes the entered characters still harder to distinguish.

FIGS. 4d-h show the similar addition of strokes corresponding to the letters “S”, “W”, “O”, “R”, and “D”, respectively. The strokes of each new character overlap with those of the previously entered character, making it increasingly difficult for an observer to identify the characters contained within the strokes.

The previously entered strokes have been illustrated in FIGS. 4b-4h using dotted lines in order to clarify the overlapping to the reader. In practice, the purpose of the overlapping is to obfuscate the entered text and such a distinction in some embodiments will therefore not be made (e.g. both old and new strokes will be similarly represented). However, since this may be confusing to the user (for example where the passcode contains a large number of characters), in other embodiments the old strokes (e.g. those corresponding to previously entered characters) may be represented differently to recent ones. Differentiating the strokes in this way assists the user in entering the current character, whilst still obfuscating the older strokes from any observers. Suitable means of differentiating the strokes may include colour, line style, blurring, flashing, and motion.

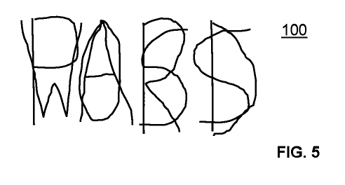

In the embodiment shown in FIG. 3 the strokes of a given character were overlapped with just those of adjacent characters in the entered string. However, this is not necessarily the case. FIG. 5 illustrates a set of strokes 500 in which non-adjacent character have been overlapped. In this example, the passcode string “PASSWORD” has been divided into two concatenated substrings (“PASS” and “WORD”), each of which has been overlapped character-by character with the other. In this way, the first characters of the two substrings have been overlapped with each other, as have the second, and so on. The resulting overlapped strokes 500 are far less legible to an observer than the strokes of FIG. 2.

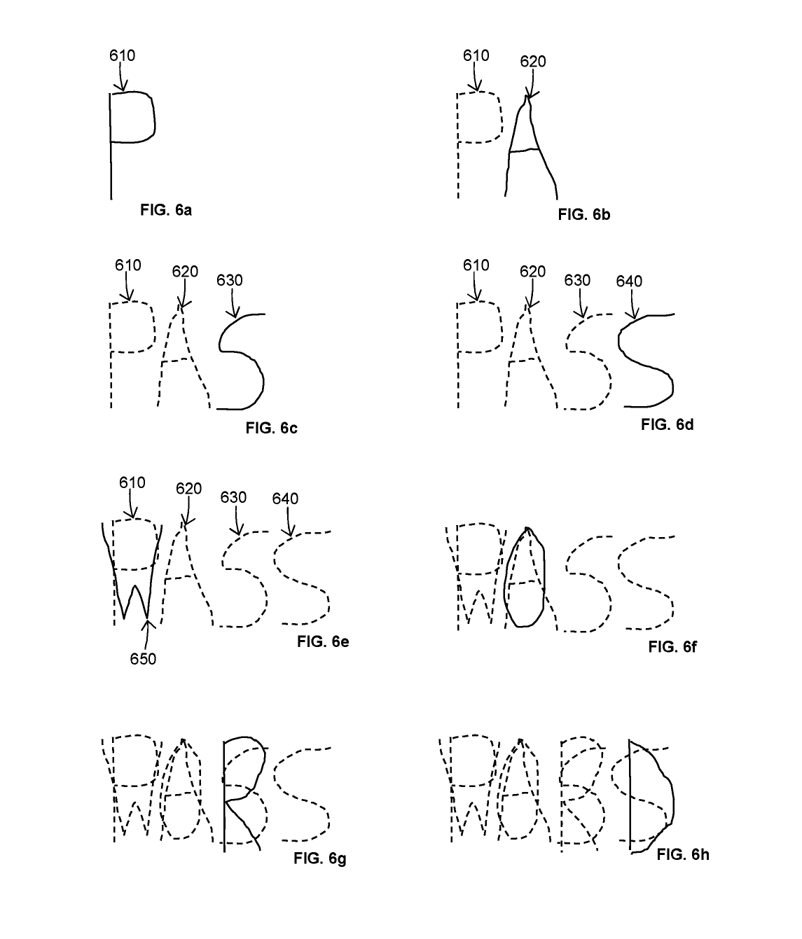

FIGS. 6a-h illustrates the manner by means of which the strokes 500 of FIG. 5 are entered.

First of all, in FIG. 6a, the user inputs the strokes 601 that make up the character “P”.

In FIG. 6b the strokes 601 of the character “P” are shown, for clarity in dashed lines. However, as discussed before, in practice there may be no differentiation between old and new strokes. The user has entered the strokes 602 that make up the character “A” to the right of those that make up the letter “P”. In this example, the new strokes 602 do not overlap the strokes 601 that make up the preceding character, but in other embodiments they may.

In FIGS. 6c and 6d the above steps are repeated for the entry of the strokes 603, 604 making up the characters “S” and “S”. The entered strokes therefore make up the characters “PASS”, the first substring of the passcode.

Up to this point, the entered strokes may be readily intelligible to an observer. However, this ceases to be the case as the second substring is entered.

In FIG. 6e, the first character (“W”) of the second substring (“WORD”) has been entered using strokes 605 that overlap those 601 of the first character (“P”) of the first substring (“PASS”). The first characters of each substring are obfuscated to observers by the overlapping, and potentially also by the spatial arrangement of the two substrings.

FIGS. 6f-e show the addition of strokes corresponding to remaining letters of the second substring “ORD”, positioned so as to overlap the second, third and fourth characters of the first substring, respectively.

In the example illustrated in FIGS. 5 and 6a-h, the passcode has been divided into two substrings, which are entered separately according to a predefined special arrangement (in this case, overwriting of corresponding positions in each substring). In other examples, different spatial arrangements and numbers of substrings may be used instead—for example the division of passcode into three substrings, two of which do not overlap and the third of which partially overlaps the other two.

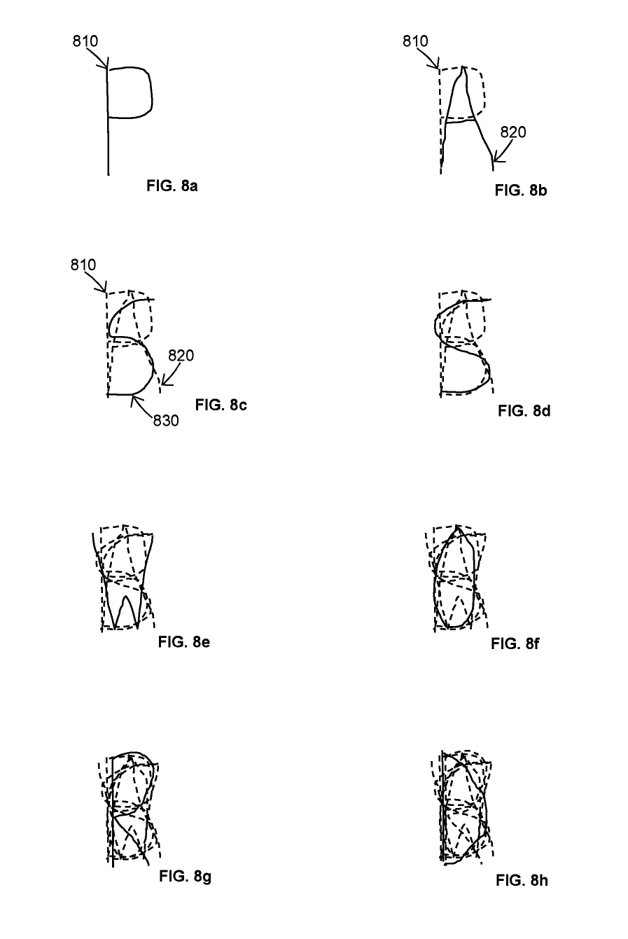

FIG. 3 illustrated an embodiment where each character overlapped only those adjacent to it in the order of the characters in the inputted string. FIG. 4 illustrated an embodiment where each character overlapped only a non-adjacent character. Different overlapping variations are possible, including the extreme case shown in FIG. 8, where every character of the passcode has been entered with strokes that overlap those of every other character. The resulting mesh of overlapped strokes 700 is virtually unintelligible to an observer and therefore very secure, due to the high degree of overlap.

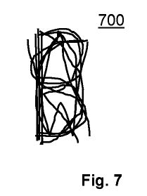

FIGS. 8a-h illustrate the means by which the user enters the strokes 700 shown in FIG. 7.

In FIG. 8a the user has entered those strokes 801 that correspond to the character

In FIG. 8b the user has added, to the strokes 801 of character “P” (now illustrated, for clarity, using a dashed line—although in practice they may be indistinguishable from newly entered strokes), strokes 802 corresponding to the letter “A”. In the illustrated example, the character “A” has been entered so as to substantially overwrite the character “P”, but lesser degrees of overlapping are also possible.

In FIG. 8c the strokes representing characters “P” and “A” have again been substantially overwritten, this time by strokes 403 representing the letter “S”.

FIGS. 8d-h show, progressively, the entry of strokes representing the remaining characters (“S”, “W”, “O”, “R”, and “D”) of the passcode.

With the entry of each additional stroke, the entered characters become increasingly difficult to distinguish, and when sufficient overlap is used the obfuscation of the entered characters is so great that they are illegible to an observer even after a small number of strokes have been entered.

In some embodiments, the level of obfuscation may be satisfactory when just a few characters have been entered, and further obfuscation may impede the entry of subsequent characters by the user as the display becomes cluttered. For this reason, representations of strokes may be removed from the display or otherwise distinguished from new strokes (e.g. by colour) after a predetermined period of time, or after a predetermined number of characters or strokes have been entered. For example, only the current stokes and those of the previous two characters might be displayed, or only the 10 previously entered strokes, or just those entered in the last second. In other embodiments, all entered strokes will remain until the entire input string has been entered, to maximise the degree of obfuscation.

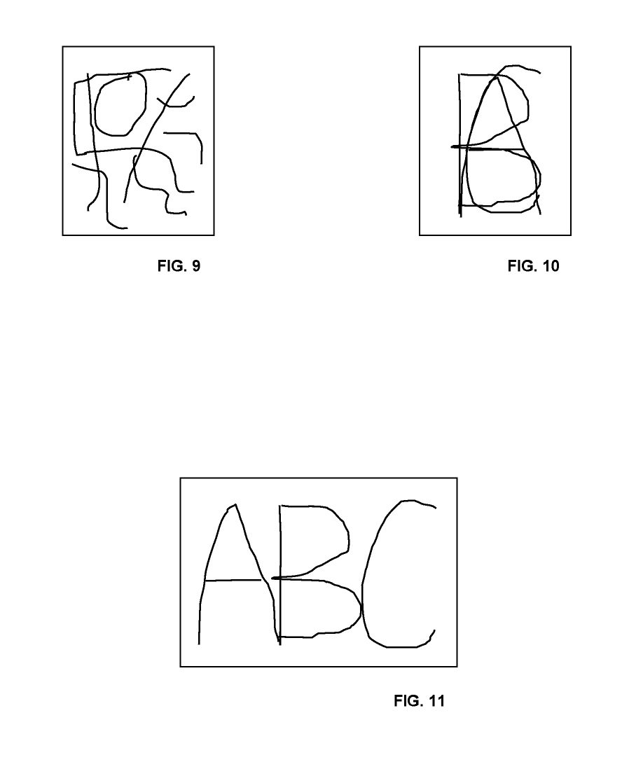

It will be understood that the extent of the obfuscation is greatest when large numbers of previously entered strokes are visible. The obfuscation is, accordingly, least when the initial strokes of the passcode are entered (for example during entry of the first character). To address this, representations of dummy strokes may (in some embodiments) be displayed during at least the inputting of the first character. The dummy strokes may be drawn onto the display as though real strokes had been received, or they may be predefined as an image that is displayed, for example as a background to a stroke receiving portion of the display. The dummy strokes may be predefined, based upon previous input by the user (for example historical stroke inputs), or randomly or pseudo-randomly generated. Examples of such dummy strokes are shown in FIGS. 9, 10 and 11, which show a random stroke pattern, overlapping character strokes, and non-overlapping character strokes, respectively. Other patterns of dummy strokes are also possible. The dummy strokes may, in some embodiments, cease to be displayed once sufficient real strokes have been received to provide effective obfuscation. Either way, the dummy strokes are not resolved into characters.

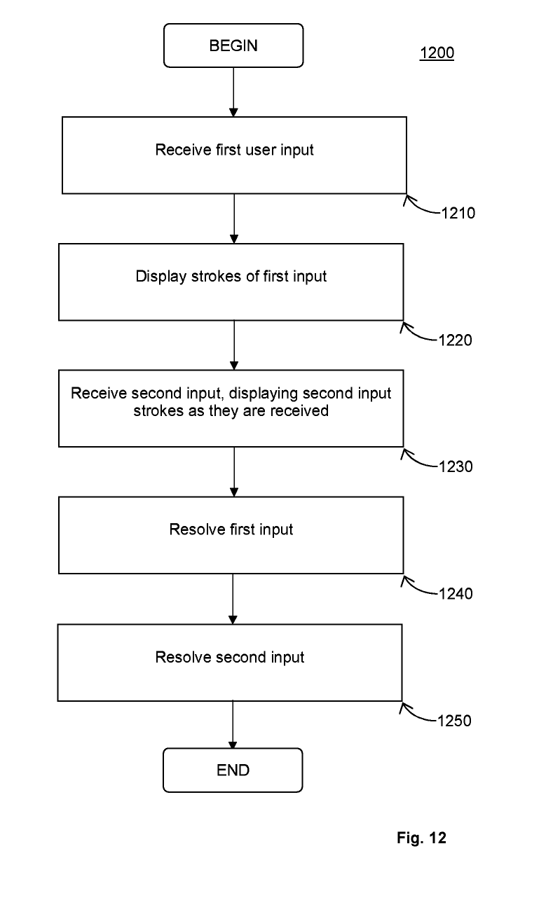

FIG. 12 illustrates an exemplary method 1200 that is suitable for handling the overlapped inputs described above. The method begins with the reception 1210 of a first user input. The first user input may comprise a set of one or more strokes made by the user, for example using a stylus on a touch screen.

Representations of the strokes of the first input are displayed 1220 after they are received 1210. In some embodiments the representation of a stroke is displayed during or immediately after the reception of that stroke, and in other embodiments it is displayed after all the strokes making up the first user input have been received.

Whilst the representations of the first set of strokes are displayed, a second set of strokes corresponding to a second user input is received 1230. The second set of strokes at least partially overlaps the first set of strokes, for example in the manner described above in relation to the overlapping between the strokes making up characters. Representations of the second set of strokes are displayed as the second set of strokes are received·for example during the entry of each stroke, or immediately after an entire stroke has been entered.

The first and second characters are then resolved 1240, 1250 from the first and second sets of strokes. Although the illustrated method shows the resolution of the first character before the resolution of the second character, the resolutions can be performed in any order supported by the character recognition technique that is used.

Although the strokes that that make up the first and second user inputs may be overlapped spatially (e.g. a stoke relating to the second character may overlie a stroke relating to the second character), in at least some embodiments they may not be overlapped temporally. That is, all of the strokes that relate to the first character will precede all of the strokes that make up the second character. Therefore, the order of the strokes and/or their timing (for example, the presence of a pause between the final stroke of the first character and the first stroke of the second character) can be used to differentiate between the separate inputs (i.e. characters). This differentiation may also use other information, for example historical input information for the user, and pattern-matching of the strokes in a character recognition model. An observer viewing the displayed representation instantaneously will be unable to deduce the order or timing of the represented strokes and this, coupled with the illegibility of the overlapped strokes, will make it extremely difficult for the observer to deduce either the characters that have been entered or the order in which they were entered.

The protection against observation of a text string entered using the above techniques may make it suitable for application in the field of user authentication, for example in the input of a passcode that must be kept secret from observers. However, it will have other applications wherever it is desirable to protect entered text from prying eyes. For example, overlapping text entry may be employed by a user when composing confidential documents, or entering private information on a publicly viewable screen (for example, entering confidential text such as an instant message during a presentation where the user's screen is visible to an audience).

FIG. 13 illustrates an exemplary method 1300 that further enhances the security of the overlapped input technique in applications when a passcode (e.g. a password, personal identification number, or other secret code) must be entered.

First of all, an input string is received 1310, using the overlapped input techniques described above. The method then determines 1320 whether or not the inputted string matches a predefined passcode. This determination may be based purely on a comparison of the inputted string with the passcode, or may also include information regarding the timing of the user entry of the strokes, and/or variance in the user entry. For example, if the authentic user is known to enter the strokes corresponding to the letter “P” with high speed and little variation, then it may be a requirement for a match that not only does a position of the character “P” in the input string match a position of “P” in the passcode, but that it is entered within particular tolerances of speed and variance. A “P” that includes a long delay between component strokes, or a “P” that departs substantially from the users historical written style might therefore not be accepted as a match, even if it otherwise matches the passcode.

If the input string and passcode do not match, some action may be taken. In the illustrated example the method simply accepts a new input string, but in other examples the method may lock a computing system, sound an alarm, or create a log of the unsuccessful passcode attempt.

If the inputted string matches the passcode then the user may be authenticated. However, if the string was entered with an adequate amount of overlapping then it may have been compromised if witnessed and understood by a third party. For this reason, the method 1300 then determines 1330 a measure of the extent of the overlap between the characters entered by the user (i.e. between the strokes used to input the characters). There are many ways in which such a measure could be determined.

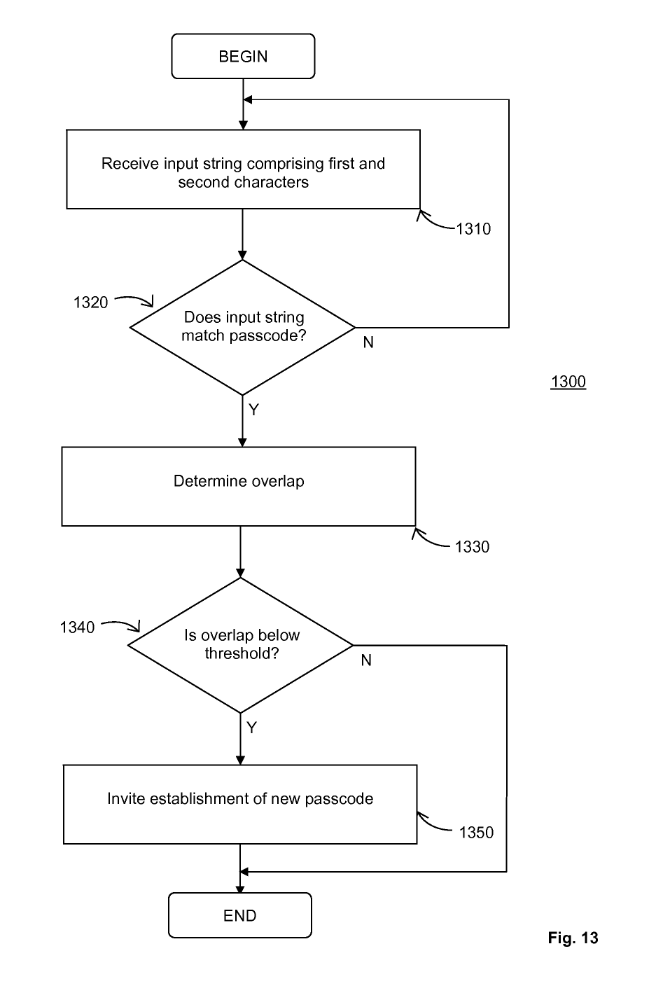

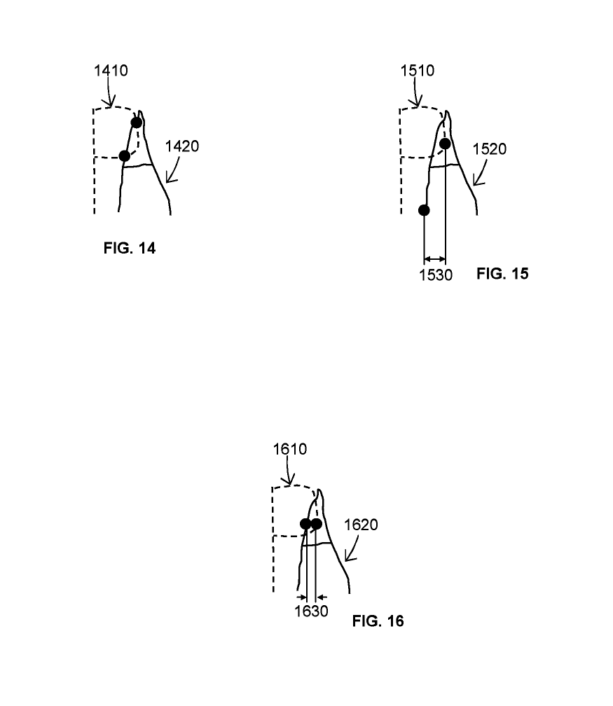

FIG. 14 illustrates one technique of determining a measure of the overlap between the stroke of two inputted characters 1410, 1420 by counting the number of times that a stroke of the second character 1420 intersects with a stroke of the first character 1410. In FIG. 14 there are two such intersections (represented by black dots), and the measure of overlapping is therefore 2.

FIG. 15 illustrates another technique of determining a measure of the overlap between the strokes of two inputted characters 1510, 1520 by measuring the maximum overlap between the two characters. In FIG. 15 the maximum overlap is the maximum overlap in the horizontal axis and is determined by comparing the extreme left and right position of the strokes making up the two characters. In the example shown in FIG. 15, the measure is the distance 1530 between the leftmost extent of the strokes that make up the second character 1520 and the rightmost extent of the strokes that make up the first character 1510 (both represented by a black dot). This distance may then be normalised, for example against the mean width of the two characters, in order to provide the measure. FIG. 15 illustrates this technique in just one axis (the horizontal axis), whereas the measure may be determined by analysis of a different axis or a combination of axes. For example, a measure may be determined according to a plurality of different axes and the mean, minimum or maximum of those results taken as a final value for the measure.

FIG. 16 illustrates another technique of determining a measure of the overlap between the strokes of two inputted characters 1610, 1620, by measuring a displacement in a similar manner as that of FIG. 15, with the limitation that the measured displacement is that between positions on the strokes that intersect with the axis of measurement. In the case of FIG. 16, the maximum overlap 1630 between stroke positions intersecting the horizontal axis is that between the two points illustrated as black dots. Once again, different axes may be selected or results from more than one axis combined.

These or other suitable techniques for determining a measure of overlap may be used in isolation or in combination to arrive at a final value for the measure of overlap between two characters. The total measure of overlap between all of the characters in an inputted string can be determined as a function of these individual values (e.g. a summation, or a maximum function).

If the measure of the overlap (either for individual characters, or for a an inputted string) falls below a predetermined threshold level, then an invitation is made 1350 to establish a new passcode, on the basis that an observer may have been able to determine the entered string by observing the representations of the users strokes. The invitation may be made by to the user (e.g. by a pop-up dialogue), or may be made to another entity if the passcode is set by an administrator, automated system for establishing passcodes, or any other suitable provider of passcodes. The invitation may be a requirement that a new passcode is provided before the user is permitted access to certain data or functionality. The invitation may comprise a disablement of the current passcode.

Without in any way limiting the scope, interpretation, or application of the claims appearing below, a technical effect of one or more of the example embodiments disclosed herein is that text can be entered in such a way that it is cannot be easily read by an observer. Another technical effect of the example embodiments is that feedback is provided to the user in the form of a representation of input strokes. Another technical effect is that passcode entry is made more secure.

Embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
receiving a first user input comprising a first set of strokes;
causing a representation of the first set of strokes to be displayed;
whilst the representation of the first set of strokes is displayed, receiving a second user input comprising a second set of strokes;
causing a representation of each of the second set of strokes to be displayed as it is received, the representation of the second set of strokes at least partially overlapping the representation of the first set of strokes;
resolving the first user input into a first character; and
resolving the second user input into a second character.

2. The method of claim 1, wherein the first and second characters are comprised by a passcode, and further comprising:
determining that characters corresponding to the passcode have been resolved;
determining a measure of the overlap between the first and second characters; and
if the determined measure of overlap is below a threshold value, inviting the establishment of a new passcode.

3. The method of claim 1, wherein:
the first and second inputs are resolved into adjacent characters in an inputted string of characters.

4. The method of claim 1, wherein:
the first and second inputs are resolved into non-adjacent characters in an inputted string of characters.

5. The method of claim 4, wherein the inputted string comprises two or more concatenated substrings, wherein the set of strokes corresponding to each character of a first of said substrings substantially overlaps the set of strokes corresponding to a character of the second of said substrings.

6. The method of claim 1, further comprising:
causing representations of a plurality of dummy strokes to be displayed prior to the first user input, wherein said dummy stokes are not resolved into characters.

7. The method of claim 1, wherein said character information is combined with at least one of stroke speed and stroke variance information in order to provide authentication against a predetermined passcode and stroke speed and/or variance information.

8. An apparatus comprising:
a processor; and
memory including computer program code,
the memory and the computer program code configured to, working with the processor, cause the apparatus to perform at least the following:
receive a first user input comprising a first set of strokes;
cause a representation of the first set of strokes to be displayed;
whilst the representation of the first set of strokes is displayed, receive a second user input comprising a second set of strokes;
cause a representation of each of the second set of strokes to be displayed as it is received, the representation of the second set of strokes at least partially overlapping the representation of the first set of strokes;
resolve the first user input into a first character; and
resolve the second user input into a second character.

9. The apparatus of claim 8, wherein the first and second characters are comprised by a passcode, and wherein the memory and the computer program code are configured to, working with the processor, cause the apparatus to further perform at least the following:
determine that characters corresponding to the passcode have been resolved;
determine a measure of the overlap between the first and second characters; and
if the determined measure of overlap is below a threshold value, invite the establishment of a new passcode.

10. The apparatus of claim 8, wherein the memory and the computer program code are configured to, working with the processor, cause the apparatus to:
resolve the first and second inputs into adjacent characters in an inputted string of characters.

11. The apparatus of claim 8, wherein the memory and the computer program code are configured to, working with the processor, cause the apparatus to:
resolve the first and second inputs into non-adjacent characters in an inputted string of characters.

12. The apparatus of claim 11, wherein the inputted string comprises two or more concatenated substrings, wherein the set of strokes corresponding to each character of a first of said substrings substantially overlaps the set of strokes corresponding to a character of the second of said substrings.

13. The apparatus of claim 8, wherein the memory and the computer program code are configured to, working with the processor, cause the apparatus to further perform at least the following:
cause representations of a plurality of dummy strokes to be displayed prior to the first user input, wherein said dummy stokes are not to be resolved into characters.

14. The apparatus of claim 8, wherein the memory and the computer program code are configured to, working with the processor, cause the apparatus to further perform at least the following:
combined with at least one of stroke speed and stroke variance information in order to provide authentication against a predetermined passcode and stroke speed and/or variance information.

15. The apparatus of claim 8, being a mobile communication device.

16. The apparatus of claim 15, being a mobile telephone.

17. (canceled)

18. A computer program product comprising a computer-readable medium bearing computer program code embodied therein for use with a computer, wherein the computer program code, when executed by the computer, perform:
receiving a first user input comprising a first set of strokes;
causing a representation of the first set of strokes to be displayed;
whilst the representation of the first set of strokes is displayed, receiving a second user input comprising a second set of strokes;
causing a representation of each of the second set of strokes to be displayed as it is received, the representation of the second set of strokes at least partially overlapping the representation of the first set of strokes;
resolving the first user input into a first character; and
resolving the second user input into a second character.

19. (canceled)
